(19) United States
(12) Patent Application Publication
(10) Pub. No.: US 2009/0021422 A1
(43) Pub. Date: Jan. 22, 2009

(54) Device and method for estimating the number of arrival signals

(75) Inventors: Yoshihiro Abe, Nagoya (JP); Kouji Shimizu, Ichinomiya-shi (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/218,734

(22) Filed: Jul. 17, 2008

(30) Foreign Application Priority Data
Jul. 20, 2007 (JP) 2007-189683

(51) Int. Cl. G01S 7/295; G01S 13/02; G06F 17/40

(52) U.S. Cl. 342/195; 702/190; 702/196

(57) ABSTRACT

A largest eigenvalue is determined among eigenvalues corresponding to a correlation matrix indicating correlations between a plurality of channels receiving incoming radar waves from an object that reflects a radar wave as a reference eigenvalue λ₁. A ratio Rλᵢ (=10 log 10(λᵢ/λ₁)) is calculated of each eigenvalue λ₂ to λ_{N} to the reference eigenvalue λ₁. Eigenvalues among the reference eigenvalue λ₁ and the eigenvalues λ₂ to λ_{N} of which the eigenvalue ratio Rλᵢ is greater than a noise threshold TH are identified as eigenvalues in signal space. Eigenvalues of which the eigenvalue ratio Rλᵢ is equal to the noise threshold TH or less are identified as eigenvalues in noise space. The number of eigenvalues identified as the eigenvalues in signal space is counted as the number of arrival signals.

### CROSS-REFERENCE TO RELATED APPLICATION

This application is related to Japanese Patent Application NO. 2007-189683 filed on Jul. 20, 2007, the contents of which are hereby incorporated by reference.

### BACKGROUND OF THE INVENTION

1. Field of the Invention

The present invention relates to a radar device, and in particular to a radar device receiving incident waves including reflected radar waves from an object using a plurality of channels and, based on a correlation matrix indicating correlations of reception signals between reception channels, estimating the number of arrival signals (i.e., estimates the number of distinct reflection waves).

2. Description of the Related Art

Conventionally, a following radar device is known. The radar device uses an array antenna configured by a plurality of antenna elements and estimates a direction of arrival (DOA) of a plurality of radio waves simultaneously arriving at the array antenna.

As a method of estimating the DOA of the radio waves, a multiple signal classification (MUSIC) method, an estimation of signal parameters via rotational invariance techniques (ESPRIT) method, and the like are known. In these methods, a direction spectrum is generated based on a correlation matrix indicating correlations between reception signals received by each antenna element (also referred to as channels). High-resolution estimation is performed by the direction spectrum being scanned.

An overview of the MUSIC method will be described below. The array antenna is formed by a so-called linear array in which N-number of antenna elements (N is an integer of 2 or more) are aligned equal distances apart.

First, a reception vector X(k) expressed by Equation (1) is configured for pieces of sampling data X₁(k), X₂(k), to X_{N}(k) acquired via the array antenna at a sampling time kΔT (ΔT is a sampling interval and k is a natural number). Next, the reception vector X(k) is used to determine an auto-correlation matrix R_{XX} of N rows and N columns in adherence to Equation (2).

Here, T is a vector transposition. H is a complex conjugate transposition.

X(k)={x₁(k),x₂(k), . . . , x_{N}(k)}^{T} Equation (1)

R_{XX}=X(k)X^{H}(k) Equation (2)

Next, eigenvalues λ₁ to λ_{N} (where λ₁≧λ₂≧ . . . ≧_{N}) of the auto-correlation matrix Rxx are determined. The number of arrival signals L (<N) is estimated from a number of eigenvalues greater than a noise threshold TH set in advance. In addition, eigenvectors e₁ to e_{N} corresponding to the eigenvalues λ₁ to λ_{N} are calculated.

Then, a noise eigenvalue vector E_{NO} composed of an eigenvector corresponding to (N−L) number of eigenvalues that are equal to or less than the noise threshold TH is defined by Equation (3). A performance function P_{MU}(θ) expressed by Equation (4) is determined with a(θ) representing a complex response of the array antenna regarding direction θ.

$$\begin{matrix}{E}_{NO} = \{ {e}_{L + 1} , {e}_{L + 2} , … , {e}_{N} \} & Equation ( 3 ) \\ {P}_{MU} ( θ ) = \frac{{a}^{H} ( θ ) a ( θ )}{{a}^{H} ( θ ) {E}_{NO} {E}_{NO}^{H} a ( θ )} & Equation ( 4 )\end{matrix}$$

When θ matches the DOA of the incident radar waves, the direction spectrum (referred to “MUSIC spectrum”) obtained from the performance function P_{MU}(θ) diverges and form sharp peaks. Therefore, estimation values θ₁ to θ_{L} of the DOA can be determined by searching for the peaks in the MUSIC spectrum (i.e., null points).

As described above, in the MUSIC method (also in the ESPRIT method), the number of arrival signals L is required to be accurately estimated during a process of calculating the DOA. Therefore, it is important to appropriately set the noise threshold TH.

Noise can be attributed to various factors. For example, in Japanese Patent Laid-open Publication No. 2006-47282, a following device is proposed. The device focuses on intensity of the noise changing depending on frequency. The device sets different noise thresholds TH based on a frequency of a beat signal (i.e., a distance from an object or the like).

When a large number of snapshots can be secured, Akaike Information Criteria (AIC), Minimum Description Length (MDL), and the like based on a maximum likelihood method are known.

The eigenvalues λ₁ to λ_{N} have a correlation with reception strength. Therefore, overall reception strength may be boosted regardless of signal elements and noise elements through reception of a strong radio wave or the like. In this case, as shown in FIG. 7, eigenvalues based on the noise element become greater than the noise threshold TH. Therefore, the eigenvalues are mistakenly determined to be those of the signal elements, causing the estimation of the number of arrival signals to increase.

Specifically, a state such as this is known to occur in a vehicle-mounted radar device and the like that are used in an environment including a large amount of clutter from roads and the like (i.e., unnecessary radio waves generated by reflection). When a sufficient number of snapshots cannot be secured and when detecting of direction is required to be performed in real-time with AIC or MDL, the accuracy of estimating the number of arrival signals significantly decreases.

In particular, as with a frequency modulated continuous wave (FMCW) radar, when only a single snapshot (only a frequency that peaks in a frequency spectrum of a beat signal) can be obtained at a time for a single object at a single instance of measurement, a large number of snapshots cannot be secured during a short period of time.

### SUMMARY OF THE INVENTION

The present invention has been achieved to solve the above-described issues. An object of the present invention is to provide a method for estimating the number of arrival signals with high accuracy, even when a number of snapshots is small, and a radar device using the number of arrival signals estimating method.

In the method of the present invention made to achieve the above-described object, eigenvalues corresponding to an auto-correlation matrix indicating a correlation between a plurality of channels receiving incident radar waves (i.e., reflection waves) from an object that reflects a radar wave are determined based on the correlation matrix. The largest eigenvalue among the determined eigenvalues is chosen as a reference eigenvalue. Those eigenvalues (among the many eigenvalues) having a ratio to the reference eigenvalue greater than a predetermined threshold are identified as eigenvalues in signal space and eigenvalues of which the ratio is equal to the threshold or less are identified as eigenvalue in noise space. The number of eigenvalues identified as the eigenvalue in signal space is the number of arrival signals.

In the method for estimating number of arrival signals of the present invention, identification is made using the ratio to the reference eigenvalue, namely relative size. Therefore, the eigenvalues can be accurately identified and the number of arrival signals L can be accurately estimated even when a number of snapshots is small or when overall reception strength is boosted.

Next, in a radar device of the present invention, a transmitting and receiving means has a plurality of channels that transmit a radar wave and receive incident radar waves from an object that reflects the radar wave. A matrix generating means generates a correlation matrix indicating correlations between channels based on reception signals obtained from each channel. An eigenvalue calculating means calculates eigenvalues corresponding to the correlation matrix generated by the matrix generating means.

Then, selecting the largest eigenvalue among the determined eigenvalues as a reference eigenvalue, a means for estimating number of arrival signals identifies eigenvalues among the eigenvalues of which ratios to the reference eigenvalue are greater than a predetermined threshold as eigenvalues in signal space and eigenvalues of which the ratio is equal to the threshold or less as eigenvalue in noise space. The number of eigenvalues identified as eigenvalue in signal space is the number of arrival signals.

A direction estimating means estimates the direction of arrival of each incoming radar wave based on the eigenvalues in noise space identified by the means for estimating the number of arrival signals and the number of arrival signals.

In other words, the radar device of the present invention uses the method for estimating number of arrival signals and can achieve the same effects as the method. Moreover, the radar device can enhance estimation accuracy of the direction of arrival of the incident radar waves.

It is known that, when the direction of arrival of the incoming radar wave is estimated using the eigenvalues, a maximum number of detectable arrival signals is one less than the number of channels. Therefore, the means for estimating the incoming radar wave preferably limits the number of arrival signals to a maximum number of incoming radar wave using the following conditions. The means limits the number when the number of eigenvalues of which the ratio to the reference eigenvalue is greater than the threshold exceeds the maximum number of arrival signals set to a value smaller than the number of channels.

In the radar device of the present invention, when the radar wave transmitted and received by the transmitting and receiving means is a frequency modulated continuous wave, the matrix generating means preferably determines a beat signal from the reception signals for each channel and generates the correlation matrix for each frequency at which the frequency spectrum of the beat signal peaks.

In this case, the frequency at which the frequency spectrum of the beat signal peaks suggests existing one distinct object having a distance and a relative speed specified by the frequency. Therefore, using this frequency can prevent the number of arrival signals from being determined regardless of the reference eigenvalue being in the noise space (in other words, regardless of the number of arrival signals is zero). In other words, the reference eigenvalue is definitely an eigenvalue of the signal space. As a result, reliability of detection results can be enhanced.

### BRIEF DESCRIPTION OF THE DRAWINGS

FIG. 1 is a block diagram of an overall configuration of a radar device;

FIG. 2 is a flowchart of details of a measurement process;

FIG. 3 is a flowchart of details of a direction estimation process;

FIG. 4 is a flowchart of details of the number of arrival signals estimation process;

FIGS. 5 to 6 are graphs showing results of a experiment comparing the radar device with a conventional device; and

FIG. 7 is an explanatory diagram of problems occurring in the conventional device.

### DETAILED DESCRIPTION OF THE PREFERRED EMBODIMENTS

Embodiments of the present invention will be described with reference to the drawings.

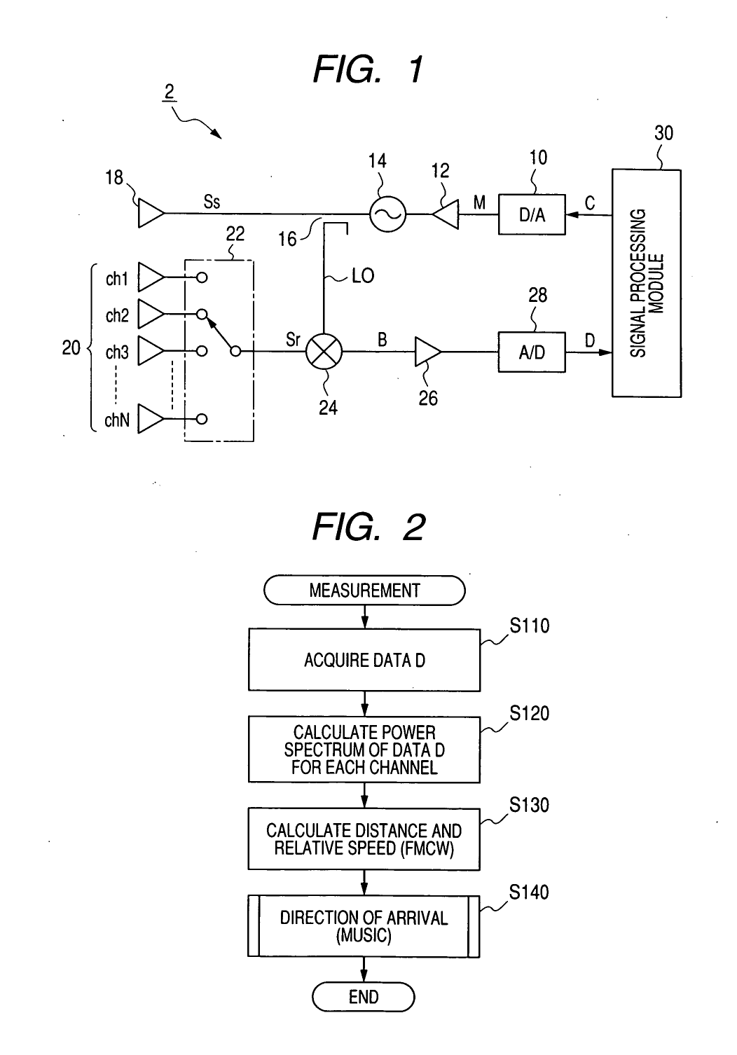

FIG. 1 is a block diagram of an overall configuration of a radar device 2 to which the present invention is applied.

The radar device 2 is mounted on a vehicle. The radar device 2 is configured as a portion of an object recognition device for a vehicle that recognizes an object present in front of the vehicle.

As shown in FIG. 1, the radar device 2 includes a digital-to-analog (D/A) converter 10, a voltage controlled oscillator (VCO) 14, a distributor 16, and a transmission antenna 18. The D/A converter 10 generates a triangular wave modulation signal M in adherence to a modulation instruction C. The modulation signal M generated by the D/A converter 10 is applied to the VCO 14, via the buffer 12. The VCO 14 changes oscillation frequency in adherence to the modulation signal M. The distributor 16 performs power distribution, dividing an output from the VCO 14 into a transmission signal Ss and a local signal LO. The transmission antenna 18 emits radar waves in adherence to the transmission signal Ss.

The radar device 2 also includes a reception-end antenna section 20, a reception switch 22, a mixer 24, an amplifier 26, an analog-to-digital (A/D) converter 28, and a signal processing section 30. The reception-end antenna section 20 is an array antenna configured from N antennas (N is an integer of 2 or more) that receive radar waves. The reception switch 22 alternatively selects any of the antennas to be the reception-end antenna section 20. The reception switch 22 supplies subsequent stages with a signal from the selected terminal as a reception signal Sr. The mixer 24 mixes the reception signal Sr supplied by the reception switch 22 with the local signal LO and generates a beat signal B. The amplifier 26 amplifies the beat signal B generated by the mixer 24. The A/D converter 28 samples the beat signal B amplified by the amplifier 26 and converts the sampled beat signal B into digital data D. The signal processing module 30 outputs the modulation instruction C to the D/A converter 10, and performs signal processing on the digital data D obtained through the A/D converter 28.

Hereafter, channels ch1 to chN are respectively assigned to each antenna configuring the reception-end antenna section 20. Sri represents a reception signal of each channel ch1 (i=1, 2, . . . , N). Bi represents a beat signal generated based on the reception signal Sri. Di represents digital data converted from a sampled beat signal Bi.

In the radar device 2 configured as described above, the distributor 16 performs power distribution of a high frequency signal (i.e., frequency modulated continuous wave [FMCW]) generated by the VCO 14 in adherence to the modulation signal M. As a result, the transmission signal Ss and the local signal LO are generated. The transmission signal Ss is transmitted via the transmission antenna 18 as a radar wave.

The radar wave (i.e., incoming radar wave) that is transmitted from the transmission antenna 18 and returns after being reflected by an object is received by each antenna (channels ch1 to chN) configuring the reception-end antenna section 20. However, only the reception signal Sri of the channel ch1 (i=1 to N) selected by the reception switch 22 is supplied to the mixer 24. The mixer 24 then couples the reception signal Sri with the local signal LO from the distributor 16 and generates the beat signal Bi. The A/D converter 28 samples the beat signal Bi amplified by the amplifier 26. The sampled beat signal Bi is loaded into the signal processing section 30 as the digital data D.

The signal processing section 30 is mainly composed of a known microcomputer including a central processing unit (CPU), a read-only memory (ROM), and a random-access memory (RAM). Moreover, the signal processing section 30 includes a calculation processing device (such as a digital signal processor [DSP]) used to perform Fast Fourier transformation (FFT) on data obtained via the A/D converter 28, and the like.

The CPU of the signal processing device 30 performs a measurement process based on the digital data D obtained via the A/D converter 28. In the measurement process, the signal processing device 30 calculates the distance and relative speed of the object reflecting the radar wave and estimates the direction in which the object is present.

### <Measurement Process>

The measurement process repeatedly performed by the CPU of the signal processing module 30 will be described with reference to a flowchart in FIG. 2.

When the process is started, first, at S110, the CPU transmits the modulation instruction C to the D/A converter 10, acquires the digital data D from the A/D converter 28, and proceeds to S120. At S120, the CPU performs FFT process on the data D acquired at S110 for each channel, thereby calculating a power spectrum of the beat signal for each channel.

At subsequent S130, based on the power spectrum calculated at S120, the CPU determines the distance from the object reflecting the radar wave and the relative speed using a known method (explanations of details thereof are omitted) applied to the FMCW radar. The CPU then proceeds to S140.

At S140, based on the power spectrum determined for each channel at S120, the CPU performs a direction estimation process for estimating the direction in which the object extracted at S130 is present. The CPU then ends the process.

### <Direction Estimation Process>

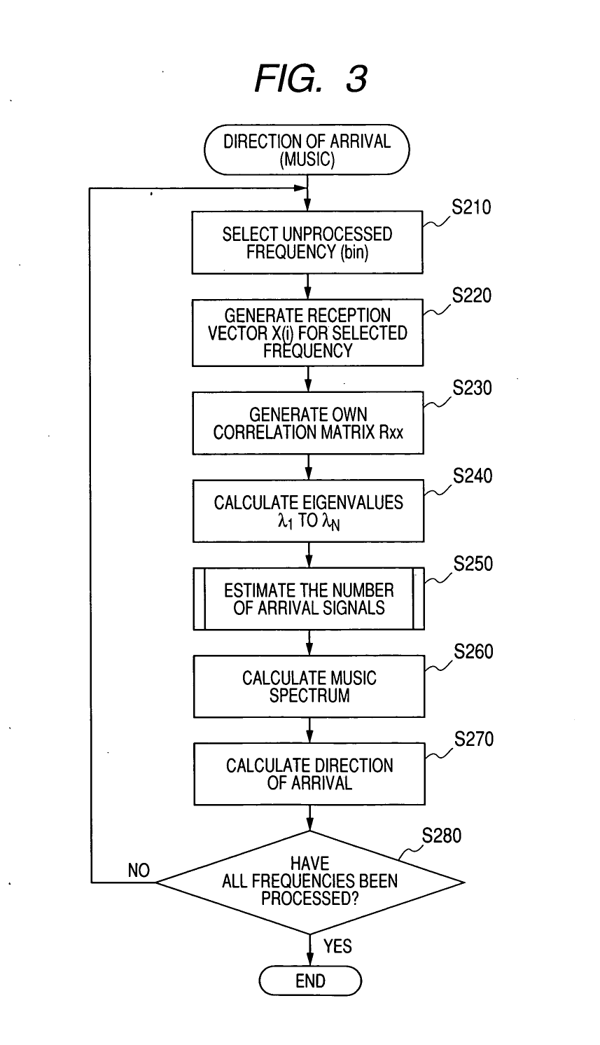

Next, details of the direction estimation process (MUSIC process) performed at the above-described S140 will be described with reference to a flowchart in FIG. 3.

First, at S210, the CPU selects, from among frequencies (bins) extracted at the above-described S130 because a signal element based on the incoming radar wave from the object is present, one frequency that has not yet been processed by the direction estimation process, from either of the separate power spectra produced during upswept or down swept frequency modulation. The CPU then proceeds to S220.

At S220, the CPU generates a reception spectrum X(i) (refer to Equation (7)). The reception spectrum X (i) is an array of signal elements (FFT processing result data) of the selected frequency extracted from the power spectra of all channels ch1 to chN. At subsequent S230, based on the reception vector X(i), the CPU generates an auto-correlation matrix R_{XX} in adherence to Equation (8), based on the reception vector X(i) and proceeds to S240.

X(i)={x₁(i),x₂(i), . . . , x_{N}(i)}^{T} Equation (7)

R_{XX}(i)=X(i)X^{H}(i) Equation (8)

At Step S240, the CPU calculates eigenvalues λ₁ to λ_{N} of the auto-correlation matrix R_{XX} generated at S230. The eigenvalues λ₁ to λ_{N} are sequentially aligned in order of largest value.

At subsequent S250, the CPU identifies eigenvalues in signal space and eigenvalues in noise space within the calculated eigenvalues λ₁ to λ_{N}. The CPU also performs the number of arrival signals estimation process to estimate the number of eigenvalues in signal space as the number of arrival signals L. The CPU then proceeds to S260.

At S260, based on an estimation result of the number of arrival signals estimation process, the CPU calculates the MUSIC spectrum and proceeds to S270.

Specifically, based on eigenvectors e_{L+1}, e_{L+2}, . . . , e_{N} corresponding to an (N−L) number of eigenvalues X_{L+1} to λ_{N} of the noise space, a noise eigenvector E_{NO} is defined by Equation (9). Then, a performance function PMU (θ) expressed by Equation (10) is defined with a (θ) representing a complex response of the reception-end antenna section 20 with respect to direction θ. The direction spectrum determined from the performance function PMU (θ) is the MUSIC spectrum.

$$\begin{matrix}{E}_{NO} = \{ {e}_{L + 1} , {e}_{L + 2} , … , {e}_{N} \} & Equation ( 9 ) \\ {P}_{MU} ( θ ) = \frac{{a}^{H} ( θ ) a ( θ )}{{a}^{H} ( θ ) {E}_{NO} {E}_{NO}^{H} a ( θ )} & Equation ( 10 )\end{matrix}$$

At S270, the CPU performs a null scan on the MUSIC spectrum determined at S260. As a result, the CPU determines incident angles θ₁ to θ_{L} of the L number of arrival signals received by each antenna configuring the reception-end antenna section 20. In other words, the CPU determines a direction in which the object reflecting the incident radar waves is present. At subsequent S280, the CPU judges whether the process is completed for all frequencies (bin) extracted because the signal element based on the incident radar waves from the object is present.

When an unprocessed frequency (bin) is present, the CPU returns to S210 and repeats the above-described process (S210 to S270) for the unprocessed frequency (bin). When all frequencies (bin) have been processed, the CPU ends the process.

### <Number of Arrival Signals Estimation Process>

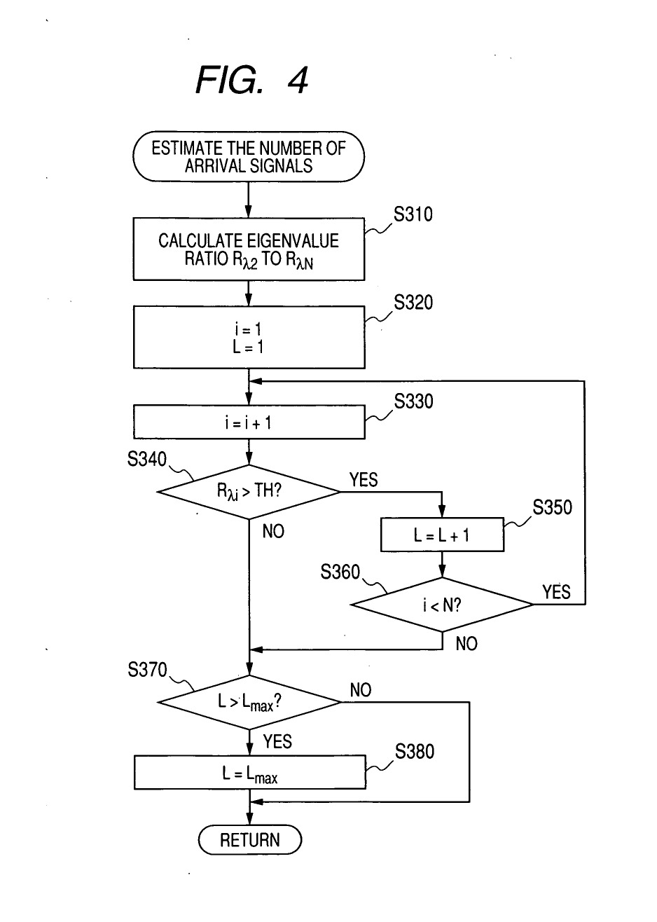

Here, details of the number of arrival signals estimation process performed at the above-described S250 will be described with reference to a flowchart in FIG. 4.

When the process is started, first, at S310, the CPU calculates a ratio (eigenvalue ratio) Rλ₂ to Rλ_{N} of each eigenvalue λ₂ to λ_{N} to a reference eigenvalue λ₁ using Equation (11). The reference eigenvalue is a maximum eigenvalue λ₁. The CPU then proceeds to S320.

$${R}_{λ n} = 10 {log}_{10} ( \frac{{λ}_{n}}{{λ}_{1}} ) \qquad Equation ( 11 )$$

At S320, the CPU initializes a parameter i for identifying the eigenvalues λ₁ to λ_{N} to 1 and initializes the number of arrival signals L to 1 (the reference eigenvalue λ₁ is counted in advance). The CPU then proceeds to S330.

At S330, the CPU increments the parameter i (i.e., i=i+1). At subsequent S340, the CPU judges whether the eigenvalue ratio Rλᵢ is greater than the noise threshold TH. A value set in advance through experiments and the like is used as the noise threshold TH.

When the eigenvalue ratio Rλᵢ is greater than the noise threshold TH, the eigenvalue λᵢ is considered to be an eigenvalue of the signal space. The CPU proceeds to S350 and increments the number of arrival signals L (i.e., L=L+1). At subsequent S360, the CPU judges whether the parameter i is smaller than the antenna number N. When the parameter i is smaller than the antenna number N, the CPU returns to S330 and repeats the comparison of the eigenvalue ratio Rλᵢ and the noise threshold TH.

At the same time, when the CPU judges that the eigenvalue ratio Rλᵢ is equal to or less than the noise threshold TH at S340 or that the parameter i is equal to or more than the antenna number N at S360, the CPU proceeds to S370. The CPU judges whether the number of arrival signals L is greater than a maximum identifiable number of arrival signals Lₘₐₓ. The maximum identifiable number of arrival signals Lₘₐₓ is set to 1≦Lₘₐₓ≦N−1 based on the antenna number N.

When the number of arrival signals L is equal to or less than the maximum identifiable number of arrival signals Lmax, the CPU ends the process. When the number of arrival signals L is greater than the maximum identifiable number of arrival signals Lₘₐₓ, the CPU proceeds to S380. The CPU completes the process with the maximum identifiable number of arrival signals Lₘₐₓ as the number of arrival signals L (i.e., L=Lₘₐₓ).

According to the embodiment, the VCO 14, the distributor 16, the transmission antenna 18, the reception-end antenna section 20, and the reception switch 22 are equivalent to a transmitting and receiving means. S220 to S230 are equivalent to a matrix generating means. S240 is equivalent to an eigenvalue calculating means. S250 (S310 to S380) is equivalent to incoming wave estimating means. S260 to S270 are equivalent to a direction estimating means.

As described above, the radar device 2 generates the correlation matrix indicating the correlations between a plurality of channels ch1 to chN that receive the incoming radar waves from the object reflecting the radar wave. The radar device 2 then determines the eigenvalues of the correlation matrix. The largest eigenvalue among the determined eigenvalues is the reference eigenvalue λ₁. The eigenvalues among the eigenvalues λ₂ to λ_{N} of which the ratio Rλᵢ (=10 log₁₀ (λᵢ/λ₁)) to the reference eigenvalue λ₁ is greater than the noise threshold TH are identified as the eigenvalues for signal space. The eigenvalues that are equal to the noise threshold TH or less are identified as the eigenvalues for noise space. The number of eigenvalues identified as those for signal space is the number of arrival signals L.

In this way, because the radar device 2 identifies the eigenvalues using the ratio Rλᵢ to the reference eigenvalue λ₁, namely relative size, the radar device 2 can accurately identify the eigenvalues and estimate the number of arrival signals L even when the number of snapshots is small or when the overall reception strength is boosted. As a result, the DOA of the incident radar wave (in other words, the position of the object reflecting the radar wave) can be accurately detected.

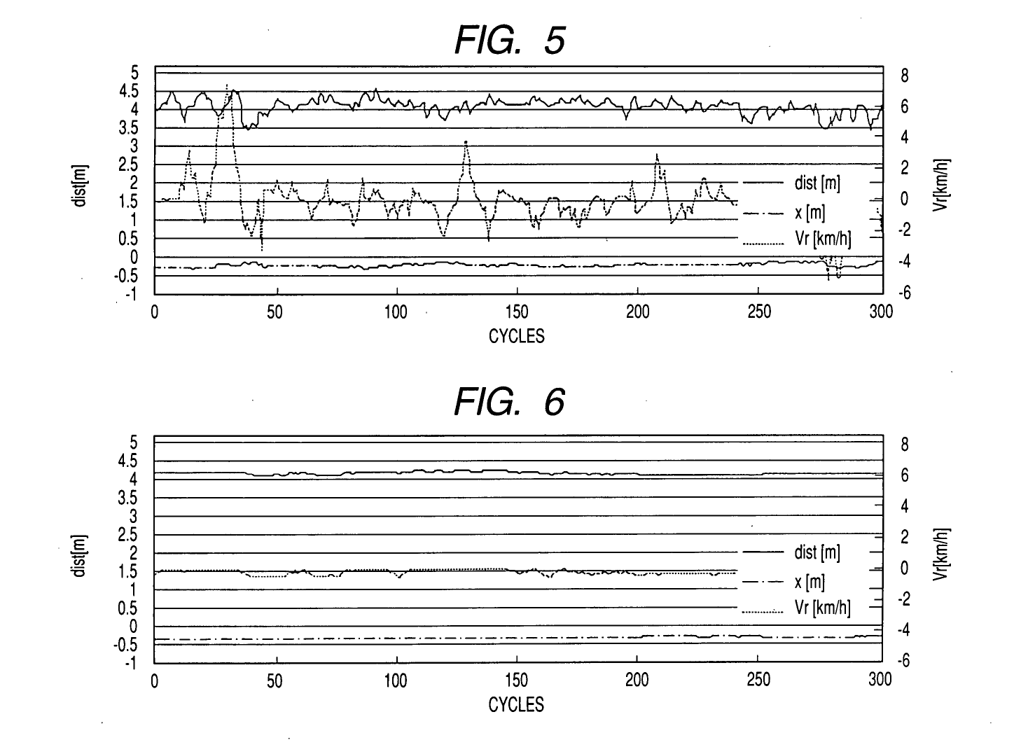

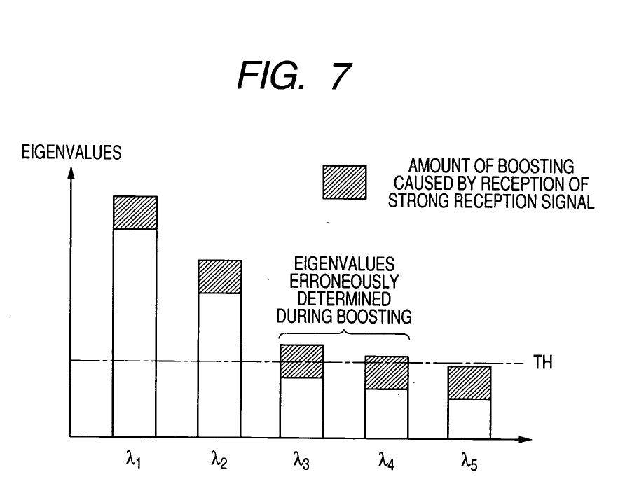

Here, FIGS. 5 to 6 are graphs of results when a relative speed Vr to the object, a vertical position dist, and a horizontal position x are measured when a single object with a relative speed of 0 km/h is present at about 4 meters in front of a vehicle on which the radar device is mounted, in a direction at an angle of about −4°.

FIG. 5 shows the results when a conventional device is used that compares the eigenvalues themselves with the threshold and identifies the eigenvalues. FIG. 6 shows the results when the radar device 2 according to the embodiment is used that compares the eigenvalue ratio with the threshold and identifies the eigenvalues.

The vertical position dist and the horizontal position x indicate the position of the object by a Cartesian coordinate system, based on the distance from the object obtained by a known method of the FMCW radar and the direction of the object obtained by the MUSIC method. The horizontal position x is a position in a vehicle width direction. The vertical position dist is a position in a direction perpendicular to the vehicle width direction (direction along a road surface).

As shown in FIG. 5, in the conventional radar, the calculated number of incoming radar wave varies between 1 and 3. However, in the radar device 2, the number of incoming radar wave L is accurately estimated as 1. It is clear that the vertical position dist and the horizontal position x can be stably determined.

### Other Embodiments

An embodiment of the present invention has been described above. However, the present invention is not limited to the above-described embodiment. Various modifications can be made without departing from the spirit of the present invention.

For example, according to the embodiment, one transmission antenna and a plurality of reception antennas are provided. However, a plurality of transmission antennas and one or a plurality of reception antennas can be provided instead. In these cases, each combination between the transmission antenna and the reception antenna can serve as a channel.

According to the embodiment, an example is described in which the present invention is applied to the FMCW radar. However, the present invention can be applied to any device that has a plurality of channels receiving the incident radar waves and estimates the DOA of the incident radar waves from the eigenvalues of a correlation function indicating the correlation between each channel.

What is claimed is:

1. A method for estimating the number of arrival signals, wherein the method generates a correlation matrix indicating a correlation between a plurality of channels receiving the incident radar waves from an object that reflects a radar wave and estimates the number of arrival signals based on the correlation matrix, the method comprising:
calculating eigenvalues corresponding to the correlation matrix;
selecting a reference eigenvalue from among the calculated eigenvalues;
identifying, among the calculated eigenvalues, eigenvalues of which ratios to the reference eigenvalue are greater than a predetermined threshold; and
setting the number of identified eigenvalues as the number of arrival signals.

2. The method according to claim 1, wherein the reference eigenvalue is the largest eigenvalue among the eigenvalues.

3. A radar device comprising:
transmitting and receiving means having a plurality of channels that transmit a radar wave and receive incident radar waves from an object reflecting the radar wave;
matrix generating means for generating a correlation matrix indicating correlations between channels based on reception signals obtained from each channel;
eigenvalue calculating means for calculating eigenvalues corresponding to the correlation matrix generated by the matrix generating means;
incident wave estimating means for identifying eigenvalues as a first and a second group of eigenvalues within the eigenvalues calculated by the eigenvalue calculating means and sets the number of identified eigenvalues as the first group of the eigenvalues to be the number of arrival signals; and
direction estimating means that estimates a direction of arrival of each incident radar wave based on the second group of eigenvalues and the number of arrival signals,
wherein the incident wave estimating means selects a reference eigenvalue from among the eigenvalues, and identifies eigenvalues among the eigenvalues of which ratio to the reference eigenvalue is greater than a threshold as the first group of eigenvalues and eigenvalues of which ratio is equal to the threshold or less as the second group of eigenvalues.

4. The radar device according to claim 3, wherein the reference eigenvalue is the largest eigenvalue among the eigenvalues.

5. The radar device according to claim 4, wherein
the incident wave estimating means limits the number of arrival signals to a maximum number of the arrival signals when the number of eigenvalues of which ratio to the reference eigenvalue is greater than the threshold exceeds the maximum number of arrival signals set to a value smaller than the number of channels.

6. The radar device according to claim 4, wherein
the radar wave transmitted and received by the transmitting and receiving means is a frequency modulated continuous wave; and
the matrix generating means determines a beat signal from the reception signals for each channel and generates the correlation matrix for each frequency at which a frequency spectrum of the beat signal peaks.

7. The radar device according to claim 5, wherein
the radar wave transmitted and received by the transmitting and receiving means is a frequency modulated continuous wave; and
the matrix generating means determines a beat signal from the reception signals for each channel and generates the correlation matrix for each frequency at which a frequency spectrum of the beat signal peaks.

8. A device for estimating the number of arrival signals, the device generates a correlation matrix indicating correlations between a plurality of channels receiving incident waves from an object that reflects a radar wave and estimates the number of arrival signals based on the correlation matrix, the incident wave estimating device, wherein eigenvalues corresponding to the correlation matrix are calculated and a reference eigenvalue is selected from among the calculated eigenvalues;
eigenvalues among the eigenvalues of which ratios to the reference eigenvalue are greater than a predetermined threshold are identified; and
the number of identified eigenvalues is set as the number of incident wave.

9. The number of arrival signals wave estimating device according to claim 8, wherein the reference eigenvalue is a largest eigenvalue among the eigenvalues.
